(19) United States
(12) Patent Application Publication
(10) Pub. No.: US 2024/0157178 A1
(43) Pub. Date: May 16, 2024

(54) WEARABLE PROTECTIVE GEAR

(71) Applicant: TESTA TECHNOLOGIES T.T. LTD, Jerusalem (IL)

(72) Inventors: Yaron RESHEF, Pardesia (IL); Uri ALON, Hadar Am (IL); Elhanan SCHAHAM, Ramat Gan (IL)

(73) Assignee: TESTA TECHNOLOGIES T.T. LTD, Jerusalem (IL)

(21) Appl. No.: 18/281,745

(22) PCT Filed: Mar. 8, 2022
(86) PCT No.: PCT/IL2022/050259

§ 371 Date: Sep. 12, 2023

(30) Foreign Application Priority Data
Mar. 14, 2021 (IL) 281493

(51) Int. Cl. A62B 7/10; A62B 17/00; A62B 17/04; A62B 18/04; A62B 18/08; A62B 23/02

(52) U.S. Cl. CPC A62B 7/10; A62B 17/006; A62B 17/04; A62B 18/045; A62B 18/084; A62B 23/02

(57) ABSTRACT

This disclosure concerns a protective gear with a hood for a user that protects the user from the environment, while also minimizing exposure of the environment to contagious agents, e.g. biological contaminants, that may be exhaled by the user in case the user is infected.

### TECHNOLOGICAL FIELD

This disclosure concerns a wearable protective gear with a hood and various filtration functionalities.

### BACKGROUND ART

References considered to be relevant as background to the presently disclosed subject matter are listed below:
U.S. Pat. No. 5,140,980
U.S. Pat. No. 6,834,646
U.S. Pat. No. 8,342,179
PCT patent application publication no. WO 2013/156017
PCT patent application publication no. WO 2019/207304

Acknowledgement of the above references herein is not to be inferred as meaning that these are in any way relevant to the patentability of the presently disclosed subject matter.

### BACKGROUND

Pandemics present a unique challenge to healthcare staff that need to be heavily protected to ensure that they do not come into contact with the disease-causing microorganism. The Covid-19 pandemic is a specific case in point. One of the challenges is to protect the caregiver from inhaling infectious microorganisms, airborne viruses in the case of the Covid-19 pandemic, typically carried within aerosol particles. Facial filters have been widely used for such protection but are often insufficient for full-proof protection against highly contagious viruses and other microorganisms.

Personal hoods that fit over the head of a user provide a good protective solution and have also been widely used. However, such personal hoods aim at protecting the caregiver wearing the hood, while the air that is exhaled by the wearer is typically expelled out of the hood without any further treatment. As the caregiver can also be infected, expelled air can carry infectious microorganisms, posing a risk to adjacent persons not utilizing protective gear.

### GENERAL DESCRIPTION

The present disclosure provides a wearable personal protective gear of a unique design and functionality.

It has been realized that while hoods, particularly such that have a forced filtered air intake (namely filtered air that is pumped into the confined space within the hood), provide a high level of protection to the healthcare staff, such hoods do not protect the environment from infectious agents that may be exhaled by a healthcare staff member utilizing the hood, should he or she be infected. While filters for the exhaled air may be a solution, these cause a flow resistance and may hinder free outflow of exhaled air and, hence, discomfort and, at times, even breathing impairment.

Hence, it would be beneficial to provide wearable protective gear that protect the caregiver utilizing the gear, while also minimizing exposure of adjacent personnel from being exposed to untreated exhausted, possibly contaminated, air.

In accordance with the present disclosure at least part of the protective sheet of the protective gear, e.g. portions of the hood or portions of the gear's region overlaying the chest area, is made of a filtering sheet material that allows air to flow therethrough while filtering-out airborne material, including bacteria, viruses and exhaled aerosol particles. In such a configuration, the gear serves a dual purpose of defining a protected confined space, as well as providing a relatively large filtering surface for egress of exhaled air and excess breathing gas (typically air) that is propelled into the confined space through the air intake.

By one of its aspects, the present disclosure provides a personal protective gear that comprises a hood for fitting over an individual's head with a visor portion at its front, a confined space defined by the hood for accommodating the individual's head, a forced filtered air intake configured to supply filtered inflowing breathing gas into the confined space, and one or more filtering portions defined in the hood, the one or more filtering portions being made of a filtering sheet material configured to filtering out contaminants from exhaust gas outflowing therethrough.

In other words, the personal protective gear of this disclosure includes a hood into which breathing gas, e.g. filtered air, is introduced in a forced manner, thereby supplying the wearer with treated air for breathing from which hazardous contaminants have been removed. The hood comprises one or more filtering portions that function to filter out hazardous contaminants, e.g. biological contaminants, that may be exhaled by the wearer, to permit exhaust of filtered, non-contaminated air to the surroundings. Such a gear protects both the wearer from external contaminants and the personnel surrounding the wearer from any infectious microorganisms that may be exhaled by the wearer.

The term inflowing breathing gas is used herein to denote breathing gas that is forced into the confined space through the intake. The breathing gas is typically air, although it may also be a breathable gas mixture, such as air enriched with oxygen, or, at times, pure oxygen.

The inflowing gas is typically treated before introduction into the confined space, e.g. filtered to remove contaminants and hazardous biological agents therefrom. Thus, in some embodiments, the forced filtered air intake is couplable to or is integral with a gas filter.

The forced filtered air intake, by some embodiments, comprises an air propelling assembly for propelling the inflowing breathing gas into the confined space. By an embodiment, the air propelling assembly comprises an electrically operated pump, and the air propelling assembly is in gas communication with the and the confined space through a flexible pipe.

By other embodiments, the inflowing gas is provided from an external source, e.g. a wearable pressurized air tank, a central pressurize air supply unit, etc.

The term exhaust gas will be used to denote gas that is exhausted from the hood through the one or more filtering portions of filtering sheet material, for example exhaled air or a mixture of the exhaled air with excess inflowing gas. Hence, the exhaust gas is filtered by the filtering portions while it is exhausted from the confined space.

The filtering portion(s) is(are) configured to filter out harmful agents, e.g. disease-causing agents such as viruses, bacteria or aerosol particles carrying such disease-causing agents.

The filtering portions may constitute sufficiently large area to enable low resistance to egress of the exhaust gas. Where the filtering portion is configured as a portion of the hood, such portion may constitute at least 10%, 20%, 30%, 40% or even at least 50% out of the surface area of the hood. At times, the hood, other than the visor, may be made entirely of such filtering sheet material.

By some embodiments, the hood is made of a protective sheet (e.g. a contaminants-insulating material) and said filtering portion is integral with said protective sheet.

The filtering portions can be of any suitable shape and number, can be randomly distributed on the surface of the hood or form an ordered pattern.

The filtering sheet material is typically pliable. The gear, including the hood in its entirety may also be pliable.

The filtering sheet material may comprise at least one layer configured for filtering-out hazardous biological matter. The hazardous biological matter may be at least one of microorganisms, viruses, viruses-containing aerosol, or hazardous matter derived from microorganisms or viruses.

The forced filtering air intake, once operated, can generate a positive pressure within the confined space and, while supplying inflowing gas, also ensures that the flow of gas through the filtering sheet material is unidirectional, namely in the outflow direction only from the confined space to the exterior. However, the filtering sheet material can provide full protection to the hooded individual even in the event of flow in the opposite direction.

The filtering sheet material can comprise one or more layers. Typically, at least one of the layers can be made of a non-woven fabric, for example non-woven fabric that is capable of filtering particles larger than 0.1 μm (micrometers) carried by the exhaust gas. By some embodiments, the filtering sheet material or at least one layer thereof may also comprise one or more substances for capturing of hazardous biological materials (i.e. active filtering components) or a substance with a disinfecting activity.

The filtering sheet material may be of a single layer; or may be multi-layered, with each layer serving the same functionality (and intensifying it) or having different filtering functionality (e.g. one layer with a coarser mesh, another with finer one, etc.; or one passive filtering layer and another that comprises an absorbent or disinfecting material; etc.).

By some embodiments, the protective gear comprises a neck collar for fitting around a wearer's neck (or over his/her torso), and the hood is configured for integrating with the collar, such that the hood and the collar define together the confined space once the hood is fitted over the individual's head. According to other embodiments, the hood may comprise an integral neck collar.

According to some embodiments, the neck collar is integral with a protective clothing.

By some other embodiments, the hood is integratable or integrated with a whole-body protective suit.

When the protective gear is in the form of a garment, the filtering portions can be located on the hood and/or other parts of the garment. Thus, by another aspect, the disclosure provides a wearable personal protective gear that comprises a wearable protective garment configured for wearing over at least an upper body portion of an individual, a hood for fitting over an individual's head with a visor portion at its front that is integratable with the protective garment and defines a confined space for accommodating the individual's head, a forced filtered air intake configured to supply filtered inflowing breathing gas into said confined space, and one or more filtering portions defined in at least one of the hood and the protective garment, said one or more filtering portions being made of a filtering sheet material configured to filtering out contaminants from exhaust gas outflowing therethrough.

The wearable protective garment may be configured to cover at least the torso of the individual, at times the entire upper body portion (i.e. from the waist-line upwards), or even a whole-body protective suit.

By some embodiments, the hood is integral with the wearable protective garment.

By other embodiments, the wearable protective garment comprises a neck collar, and the hood is integratable with the neck collar.

The forced filtered air intake, by some embodiments, is formed at the hood. Alternatively, by some embodiments, the forced filtered air intake is formed at the wearable protective garment. According to other embodiments, the forced filter air intake is formed both at the hood and at the garment.

In order to provide effective filtering area, the filtering portion(s), by some embodiments, constitute at least 10% of the area of the hood and/or the protective garment, at times at least 20%, 30%, 40%, or ever at least 50% of the surface are of the hood and/or the protective garment.

By some embodiments, the filtering portion(s) are located on a section of the garment located over the chest of the individual.

The personal protective gear of this disclosure is intended and configured, by one embodiment, for use by medical staff or other caregivers; particularly for use at times of a disease or pandemic outbreak. By another embodiment, the protective gear is intended and configured for use by patients infected or suspected of being infected by a contagious disease. By a further embodiment, the protective gear of this disclosure is configured for use by cleanroom workers, e.g. in the chip-making or pharmaceutical industry or in a clean laboratory, to avoid exhalation of agents harmful to the manufacture or testing process within such a clean room.

The gear may have different sizes and may be differently configured for different individuals.

By some embodiments, the gear is liquid impermeable. By some other embodiments, the gear is disposable. By yet other embodiments, the gear is made of a sterilizable material, permitting its reuse.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic side view of a personal protective gear according to an embodiment of this disclosure with a filtering sheet material configured as part of the hood, being worn by a user.

FIG. 2 shows the gear of FIG. 1 with the hood shown in cross-section.

FIG. 3 is a close-up view of the hood of FIGS. 1 and 2, illustrating schematically the airflow within the confined space.

FIG. 4 is a schematic side view of a personal protective gear according to an embodiment of this disclosure, configured for supply of pressurized air from an external source.

FIG. 5 is a schematic view of a protective gear of an embodiment of this disclosure, in the form of a whole-body wearable gear with the filtering sheet material being configured as a portion of the chest cover of the gear.

FIG. 6 shows, schematically, the airflow pathways.

### DETAILED DESCRIPTION OF EMBODIMENTS

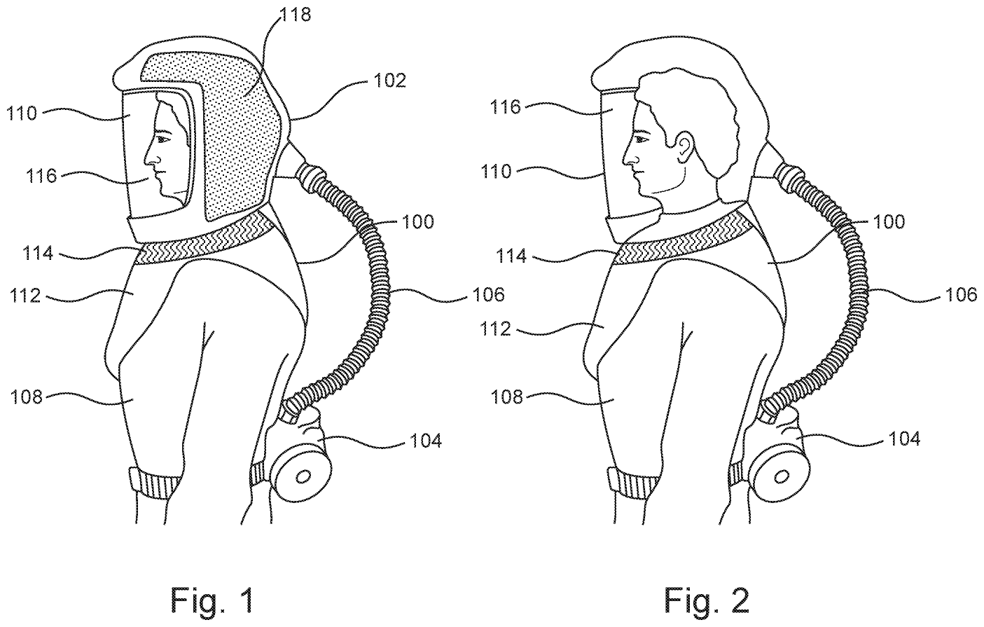

Reference is first made to FIGS. 1 and 2 showing a schematic illustration of a personal protective gear 100 according to an embodiment of this disclosure. It comprises a hood 102, made of a flexible, liquid-impermeable material and has a forced, filtered air intake 104 that is in communication with the hood through a pipe 106. Intake 104 includes a pump and a filter (nor shown). The hood 102 is configured for fitting over the head of an individual user 108 and has an integral visor portion 110 at its front, made of a flexible, transparent gas-impermeable material, positioned in front of the eyes of the user.

The gear 100 has a skirt 112, extending downward from the hood 102, that fits over the shoulder of the user 108 and is fitted with collar 114 made of an elastic material such as silicone, polyurethane, latex rubber, etc., allowing easy donning and requiring no latches, straps, ties, or the like. The collar 114 is not limited to such made of an elastic material and may be made of a non-elastic or an elastic material configured for tightening over the neck or another body portion. Once collar element 114 is attached to the hood, a confined space 116 is defined, into which filtered air inflow can be introduced.

Comprised in the hood 102 and integral therewith is a filtering portion 118 made of a filtering sheet material of the kind described herein, capable of filtering-out particulate matter from gas exhausted therethrough from the confined space 116. The filtering sheet material 118, as noted above, provides protection to the wearer from harmful agents, particularly viruses or bacteria, and at the same time permits the outflowing gas to egress without carrying harmful agents that may be exhaled by the hooded individual. The filtering sheet material may be made of a non-woven fabric capable of filtering particles larger than 0.1 μm carried by the outflowing gas, thus filtering out bacteria, pathogen-carrying aerosol, and others, by the exhaust gas. The filtering sheet material may also comprise one or more substances for capturing of hazardous biological material or a substance with a disinfecting activity. The filtering sheet material may be of a single layer material or may be multi-layered. In the case of multi-layered material, all layers may have the same functionality, thus intensifying the activity; or each layer may have a different filtering functionality (e.g. one layer with a coarser mesh, another with finer one, etc.; or one passive filtering layer and another that comprises an absorbent or disinfecting material; etc.).

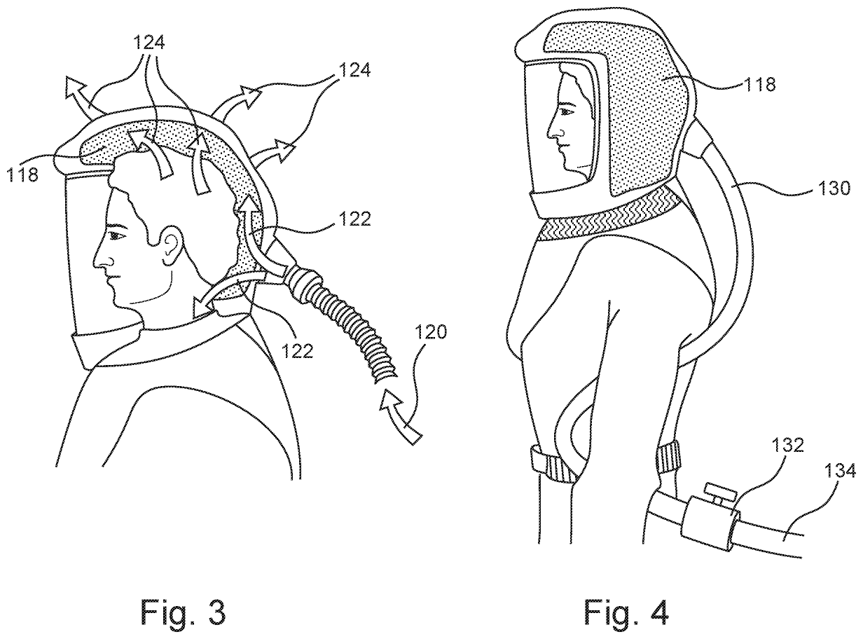

As represented schematically by arrow 120 in FIG. 3, breathing gas enters pipe 106, e.g. being forced by a pump or fed from a pressurized gas source. The breathing gas is typically air, although other breathable gas may be contemplated such as oxygen, air enriched with oxygen, etc. The forced breathing gas enters into and spread through the confined space 116, as represented by arrows 122, and the outflowing gas exists through the filter portion 118, as represented by arrows 124.

In another embodiment, illustrated schematically in FIG. 4, pipe 130 is configured for coupling, via coupling element 132, to a pressurized breathing gas feeding line 134.

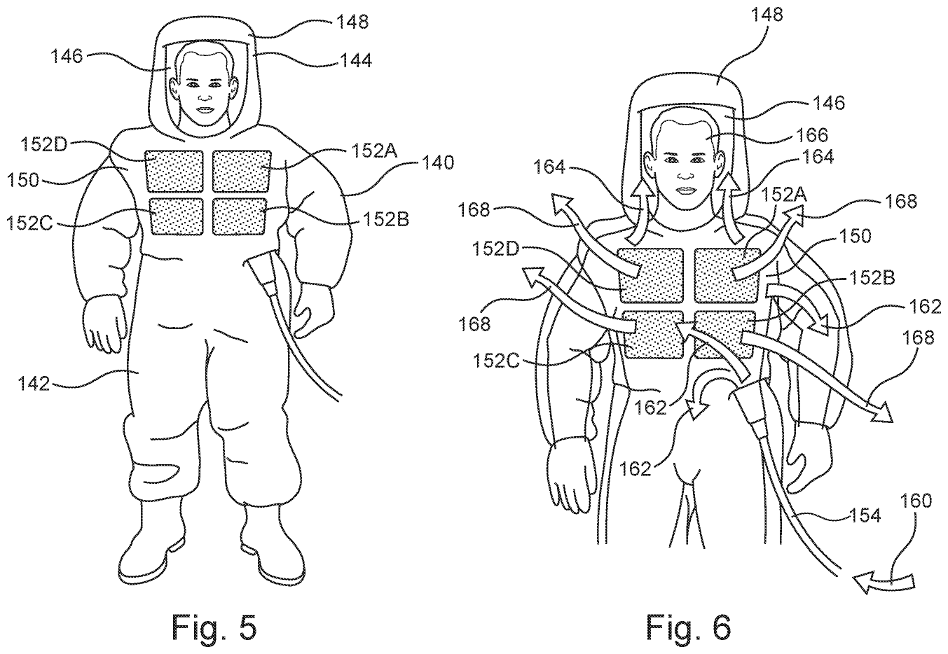

Another exemplary embodiment is shown in FIGS. 5 and 6. In this embodiment, protective gear 140 has a full body wearable suit 142 integral with a hood 144, having an integral visor element 146 and defining a confined space 148 beneath the hood. Defined on the chest portion 150 of suit 142 are a plurality of filtering portions, in this example four such portions 152A-152D, which may be of the kind described above.

Breathable gas that is forced through pipe 154, as represented by arrow 160 in FIG. 6, enters into the suit and spreads in it as represented by arrows 162, including into the confined space 148 beneath the hood, as represented by arrows 164 for breathing by the wearing individual 166. Exhaust gas outflows through filtering portions 152A-152D, as represented by arrows 168.

The gear of this disclosure may at times also be made integral with the other wearable gear, e.g. integral with a whole-body protective suit.

1. A personal protective gear comprising:
a hood for fitting over an individual's head with a visor portion at its front;
a confined space defined by the hood for accommodating the individual's head;
a forced filtered air intake configured to supply filtered inflowing breathing gas into said confined space; and
one or more filtering portions defined in the hood, said one or more filtering portions being made of a filtering sheet material configured to filtering out contaminants from exhaust gas outflowing therethrough.

2. The gear of claim 1, wherein said hood is made of a protective sheet, and said one or more filtering portions are integral with said protective sheet.

3. The gear of claim 1, wherein said one or more filtering portions constitutes at least 10% of the area of the hood.

4. (canceled)

5. The gear of claim 1, wherein said filtering sheet material is pliable.

6. (canceled)

7. The gear of claim 1, wherein the forced filtered air intake comprises an air propelling assembly for propelling said inflowing breathing gas into said confined space.

8.-10. (canceled)

11. The gear of claim 1, wherein said filtering sheet material comprises at least one layer configured for filtering-out hazardous biological matter.

12. (canceled)

13. The gear of claim 1, wherein the forced filtering air intake is configured for generating a positive pressure within the confined space.

14. The gear of claim 1, comprising a neck collar, said hood and said neck collar defining together, once fitted over the head, said confined space, the neck collar is integral with the hood or with a protective clothing.

15.-17. (canceled)

18. The gear of claim 1, wherein said filtering sheet material comprises at least one layer containing an active filtering component and/or a disinfecting material.

19. (canceled)

20. The gear of claim 1, being disposable or sterilizable.

21. (canceled)

22. The gear of claim 1, integratable with a whole-body protective suit.

23. A wearable personal protective gear comprising:
a wearable protective garment, for wearing over at least an upper body portion of an individual;
a hood for fitting over an individual's head with a visor portion at its front, integratable with said protective garment, the hood defining a confined space for accommodating the individual's head;
a forced filtered air intake configured to supply filtered inflowing breathing gas into said confined space; and
one or more filtering portions defined in at least one of the hood and the protective garment, said one or more filtering portions being made of a filtering sheet material configured to filtering out contaminants from exhaust gas outflowing therethrough.

24. The gear of claim 23, wherein said hood is integral with said wearable protective garment.

25. The gear of claim 23, wherein said wearable protective garment comprises a neck collar, said hood being integratable with said neck collar.

26. The gear of claim 23, wherein said wearable protective garment is a whole-body protective suit.

27. The gear of claim 23, wherein said forced filtered air intake is formed at said hood or at the wearable protective garment.

28. (canceled)

29. The gear of claim 23, wherein said one or more filtering portions constitute at least 10% of the area of the hood and/or the protective garment.

30. The gear of claim 23, wherein said filtering sheet material is pliable.

31.-33. (canceled)

34. The gear of claim 23, wherein the forced filtering air intake is configured for generating a positive pressure at least within the confined space.

35. (canceled)

36. The gear of claim 23, wherein said filtering sheet material comprises at least one layer containing an active filtering component and/or a disinfecting material.
